(19) United States
(12) Patent Application Publication
(10) Pub. No.: US 2011/0195280 A1
(43) Pub. Date: Aug. 11, 2011

(54) Banana plant cell

(76) Inventors: Zzu-Lun Huang, Taichung City (TW); Chih-Hung Chung, Taichung County (TW)

(21) Appl. No.: 12/661,565

(22) Filed: Mar. 19, 2010

(30) Foreign Application Priority Data
Feb. 9, 2010 (TW) 099104033

(51) Int. Cl. H01M 8/16

(52) U.S. Cl. 429/2

(57) ABSTRACT

The present invention discloses a banana plant cell, comprising at least one banana plant, at least one first electrode, and at least one second electrode. The banana plant is live and comprises organic acids as an electrolyte. The first electrode and the second electrode are used as an anode and a cathode, respectively. These two electrodes are inserted on the banana plant and are connected to each other. The banana plant cell according to the present invention belongs to a long-acting banana plant herb cell, thereby capable of solving the low efficiency problem of the fruit battery for long-term usage.

### FIELD OF THE INVENTION

The present invention relates to a cell, and in particular to a banana plant cell providing a long-lasting power supply.

### BACKGROUND OF THE INVENTION

The invention of the first battery in the world may be traced back to A.D. 1800 when a battery stack was invented by Alessandro Volta. The battery stack was formed by the following main steps. Zinc plates and silver plates were alternately arranged to each other, and a piece of cloth soaked with sulfuric acid was placed in the middle thereof for separation. Then, the two ends of the stack made up of 30 metal plates were connected with a metal wire such that stable voltage and current were generated. The values of voltage and current may vary with different combinations of metal plates or different numbers of stacked metal plates. The oxidation characteristic of the zinc electrode is higher than that of the hydrogen and silver electrode according to the oxidation potential table. After turning on the circuit, zinc is oxidized to become a divalent zinc ion which will combine with a sulfate ion, and electrons are passed to the silver electrode to perform a reduction reaction with hydrogen ions in the vicinity of the silver electrode to produce hydrogen. At this time, the silver electrode is not involved in the reaction, just as an electronic conduction plate.

However, the above-mentioned voltage battery (silver/zinc) has serious shortcomings, including the sulfuric acid as the electrolyte having high risk, hydrogen accumulated on the electrode surface, consumption of hydrogen ions and other factors, affecting the battery performance for long-term usage and its further application.

In addition, a variety of fruits, such as lemons, oranges, grapes, melons, and so on, as the “fruit battery” also has been widely used as teaching and research topics in the past two or three decades. The main operation method is that two kinds of metals having different ionization tendency (also known as strength of the metal ionization in the electrolyte, as shown in Table 1) are inserted in the fruits as the cathode and anode, respectively, that is, a simple battery system can be developed by a spontaneous electrochemical reaction. If copper and zinc are used as electrodes, for example, the potential of copper in the ionization sequence is about +0.34 V, and the potential of zinc on the ionization sequence is about −0.76 V. Therefore, in the case of the orange fruit juice as the electrolyte, the measured voltage may be about 1 V.

TABLE 1
Ionization sequence table of metallic elements

| | | | | | | | | Anode (i.e. negative) | | | | | | |
|---|---|---|---|---|---|---|---|---|---|---|---|---|---|---|
| Cathode (i.e. positive) direction | | | | | | | | direction | | | | | | |
| Small ionization tendency | | | | | | | | Large ionization tendency | | | | | | |
| Au | Ag | Hg | Cu | H | Pb | Sn | Ni | Pd | Fe | Zn | Mg | Ca | Na | Li |

In general, fruits are rich in water and various electrolytes. To take an example of the common lemon, the citric acid content is much higher than that in other fruits. Thus, with the copper and zinc electrode as materials of the cathode and anode, a lemon cell with about 0.9 V of the voltage may be developed, and the cell reaction is as follows:

The oxidation half-reaction of zinc electrode: 3Zn+2C₆H₈O₇→Zn₃(C₆H₅O₇)₂+6H⁺+6e⁻

The reduction half-reaction of copper electrode: 2H⁺+2e⁻→H_{2(g)}

The overall cell reaction: 3Zn+2C₆H₈O₇→Zn₃(C₆H_{S}O₇)₂+3H_{2(g)}

The potential change of the lemon cell is vulnerable to electrode materials, and the magnitude of changes is from 1.4 V (Copper/Magnesium) to 0.2 V (Copper/Nickel). In the case of other fruits substituted for lemon, the potential of the fruit battery is also changed due to the difference of contained water and electrolytes, but the magnitude of changes is only between 0.95 V (tomato) and 0.45 V (melon). It is shown that the potential of the fruit battery and fruit acidity have a very significant relation, so that the potential of the cathode changes, thereby affecting the performance of the cell potential.

Nevertheless, unlike the commercially available primary battery, the fruit battery can not be used as the power source of the bulb in a flashlight, resulting mainly from having small current, and electrolytes and the state of organizations within the fruits not providing high-current operation, ion transmission and electron transmission. In addition to small current, another main drawback of the fruit battery with higher safety is that hydrogen generated by the cathode will still accumulate on the electrode surface, thus affecting the cell performance for long-term usage under the premise of hydrogen not able to be expelled out by the tissue in the fruit. Moreover, for the fruit battery, the electrolytes in the fruit will gradually reduce, thus not capable of generating electrical power for a long time. Therefore, searching for suitable fruit batteries is also an issue desirable to be explored.

Banana is a perennial herbaceous monocotyledon, its scientific name being Musa sapientur L., its family belonging to Musaceae, its alias comprising golden banana, bow banana, sweet banana, plantain. There are wide kinds of bananas which are edible and medicinal, and grow very fast. The main producing regions of bananas include Central and South America, Africa, Southeast Asia and the Asia-Pacific region, while people in the Central and South America region call the banana as the Green Gold, signifying its economic importance.

### SUMMARY OF THE INVENTION

In view of the aforementioned drawbacks, an object of the present invention is to provide a banana plant cell for solving the low efficiency problem of the fruit battery for long-term usage.

According to the object of the present invention, a banana plant cell is provided. The banana plant cell comprises at least one banana plant, at least one first electrode and at least one second electrode. Each the banana plant is a live plant and comprises at least one organic acid as an electrolyte. The first electrode as an anode is inserted on the banana plant. The second electrode as a cathode is inserted on the banana plant and connected electrically with the first electrode.

The banana plant cell according to the present invention has one or more advantages as follows:

(1) The banana plant cell in accordance with the present invention is constructed on the banana plant which is continuously growing, that is, the banana plant still has normal physiological metabolism. Therefore, during the cell works, organic salts generated by the anode can be taken away from the electrode with pipelines for transporting water, and hydrogen can be also released via stomata in the plant tissue without the phenomenon of accumulating salts and gas on the electrode surfaces. Therefore, the banana plant cell can work stably over a long period of time to achieve the functionality of long-term usage.

(2) The present invention uses the whole banana plant to replace fruits. The banana plant for generating electrical power is live and thus is able to produce ceaselessly the required organic acids as the electrolyte, not facing problems of, for example, limited organic acids as the electrolyte within fruits, the short storage life of fruits, and being easy to rot and damage for fruits, thereby capable of supplying electrical power for a long time.

(3) In the era of demanding energy conservation and carbon reduction and in the perspective of generating electrical power, it has become a very important innovation how to generate electricity under the premise of not producing carbon dioxide. On earth, plants are the largest group of absorbing carbon dioxide. Accordingly, the present invention makes use of plants to generate electricity and to reduce the amount of carbon dioxide on earth, so as to attain a double advantage.

(4) Due to the banana plant cell using a live plant and capable of supplying electrical power for a long time, it can be applied to a variety of remote areas having a difficulty in power supply, for example, providing required electricity to a sensor for detecting landslides, or to a communication base station located in the mountains.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic diagram of a banana plant cell in accordance with an embodiment of the present invention;

FIGS. 2A and 2B illustrate respectively a schematic diagram of a banana plant cell and an equivalent circuit thereof in accordance with another embodiment of the present invention;

FIG. 3 illustrates an average voltage curve obtained by means of monitoring continuously a banana plant cell for seven days in accordance with Example 4 of the present invention;

FIG. 4 illustrates an average current curve obtained by means of monitoring continuously the banana plant cell for seven days in accordance with Example 4 of the present invention; and

FIG. 5 illustrates an average power curve obtained by means of monitoring continuously the banana plant cell for seven days in accordance with Example 4 of the present invention.

### DETAILED DESCRIPTION OF THE PREFERRED EMBODIMENTS

Exemplary embodiments of the present invention are described herein in the context of a banana plant cell. The same reference indicators will be used throughout the drawings and the following detailed description to refer to the same or like parts.

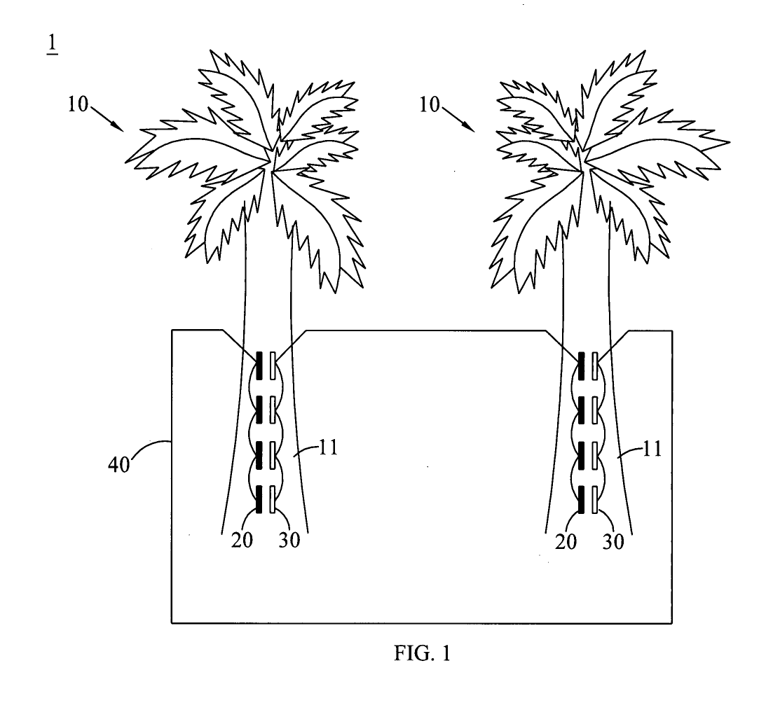

Please refer to FIG. 1 illustrating a schematic diagram of a banana plant cell in accordance with an embodiment of the present invention. The scientific name of the banana plant according to the present invention is Musa sapientum L. The banana plant belongs to Musaceae, and is a large herbaceous monocotyledon. In FIG. 1, the banana plant cell 1 comprises live banana plants 10, first electrodes 20 used as an anode, and second electrodes 30 used as a cathode. The first electrodes 20 and second electrodes 30 are inserted on pseudostems 11 of the banana plants 10 and are connected electrically to each other by conducing wires 40. Wherein, the first electrodes 20 and second electrodes 30 are inserted on the same one banana plant 10 in parallel and inserted on the different banana plants 10 in series.

Wherein, a selected material of the first electrodes 20 may be an active metal and does not harm the environment or the plant itself, comprising magnesium, zinc, or aluminum. A selected material of the second electrodes 30 may be an inactive metal, such as copper, silver, platinum and gold, or may be graphite.

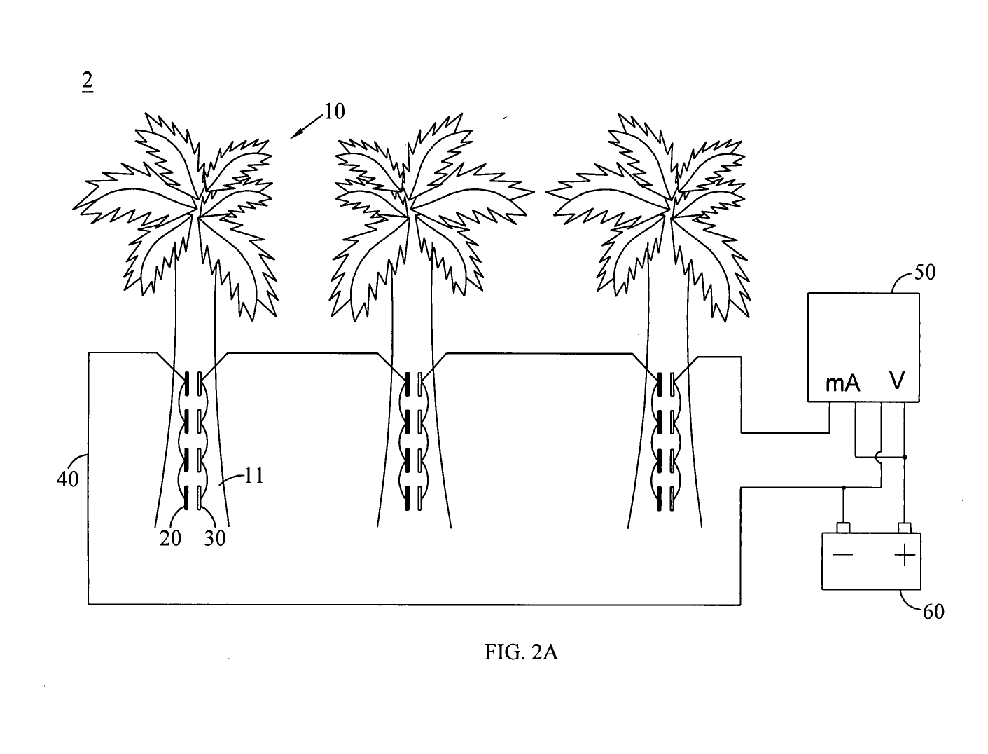

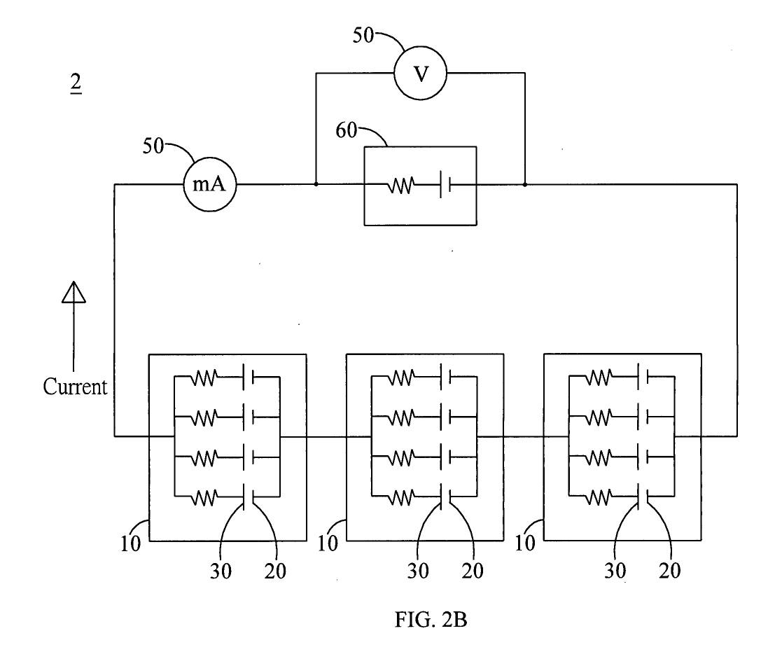

Please refer to FIGS. 2A and 2B, a schematic diagram of a banana plant cell and an equivalent circuit thereof in accordance with another embodiment of the present invention are provided, respectively. In the figures, the banana plant cell 2 comprises banana plants 10 which are live plants, first electrodes 20 as an anode (i.e. negative electrode), second electrodes 30 as a cathode (i.e. positive electrode), a recorder 50, and a load 60. The first electrodes 20 and the second electrodes 30 are inserted on the pseudostems 11 of the banana plants 10, and are electrically connected to each other via conducing wires 40. Wherein, the recorder 50 can be used to recorder voltage and current generated by the banana plant cell 2. The load is an object to be supplied with electricity, such as an electric lamp, a light bulb, a rechargeable battery (also called as secondary battery) or a motor.

### Example 1

### Copper-Zinc Electrodes

In this embodiment, zinc is selected as the first electrode, and copper is selected as the second electrode. One copper electrode (2.0 mm*60 mm) and one zinc electrode (2.0 mm*60 mm) are inserted on the pseudostem of the same one banana plant, and are connected electrically to each other, in which 1.001 V of direct voltage can be measured so as to confirm that the banana plant cell according to the present invention can definitely generate electricity.

### Example 2

### Gold-Zinc Electrodes

In this embodiment, zinc is selected as the first electrode, and gold is selected as the second electrode. One gold coin (14 mm of diameter) and two zinc electrodes (1.6 mm*51 mm) are inserted longitudinally on the pseudostem of the banana plant (about 6-8 months) with about 12 mm of depth, and are connected electrically to each other, wherein the two zinc electrodes are linked in parallel. The banana plant is further connected with a voltage and current recorder and a load having 2.3 ohm of load resistance via a conducting wire. Because the difference in ionization tendency between gold and zinc is larger than that between copper and zinc, the outputted voltage should be higher. The constructed banana plant cell in this embodiment can be measured with 1.234 V of direct voltage and 0.12 mA of current so as to confirm that the banana plant can be definitely applied to generating electricity and be used as a battery or a source of power supply.

### Example 3

### Silver-Zinc Electrodes

Zinc is selected as the first electrode, and silver is selected as the second electrode in this embodiment. One silver coin (41 mm of diameter) and four zinc electrodes (1.6 mm*51 mm) are inserted longitudinally on the pseudostem of the banana plant (about 6-8 months) with about 40 mm of depth, and are connected electrically to each other, wherein the four zinc electrodes are linked in parallel. The banana plant is further connected with a voltage and current recorder and a load having 2.3 ohm of load resistance via a conducting wire. Compared to the difference in ionization tendency between copper and zinc, the difference in ionization tendency between silver and zinc is larger, and thus the outputted voltage should be higher. As a result, the banana plant cell in this embodiment is actually measured with 1.259 V of direct voltage and 1.17 mA of current, confirming that the banana plant is definitely able to generate electricity and to use as a battery or a source of power supply.

### Example 4

### Copper-Zinc Electrodes

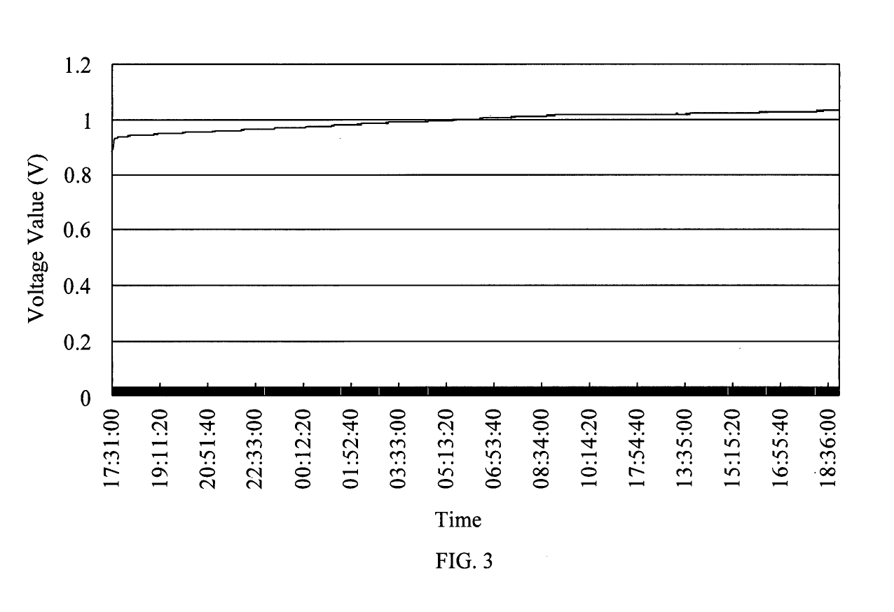

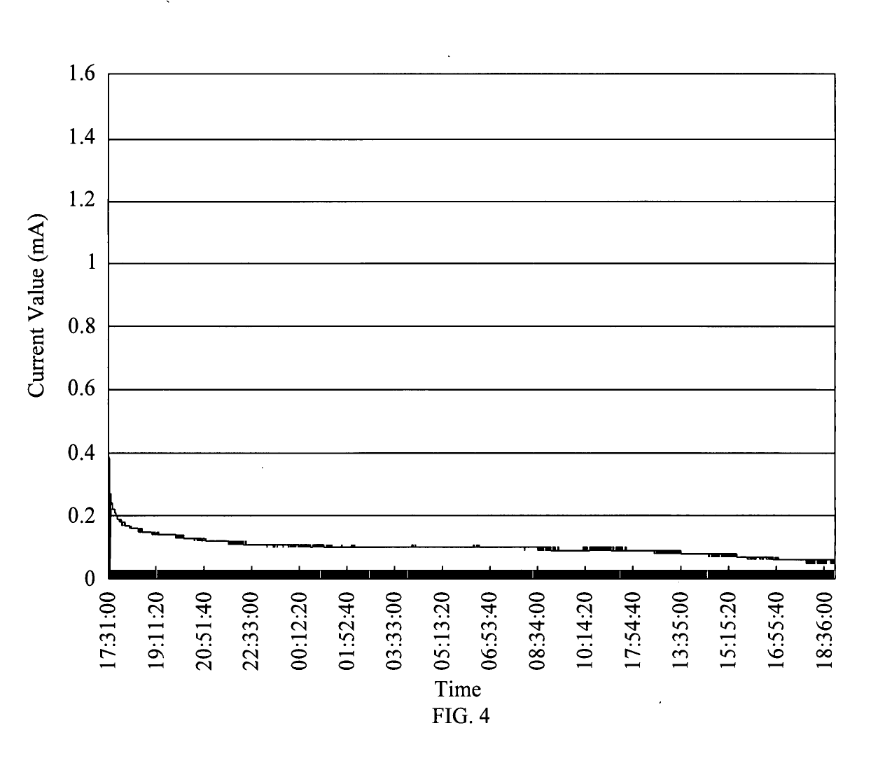

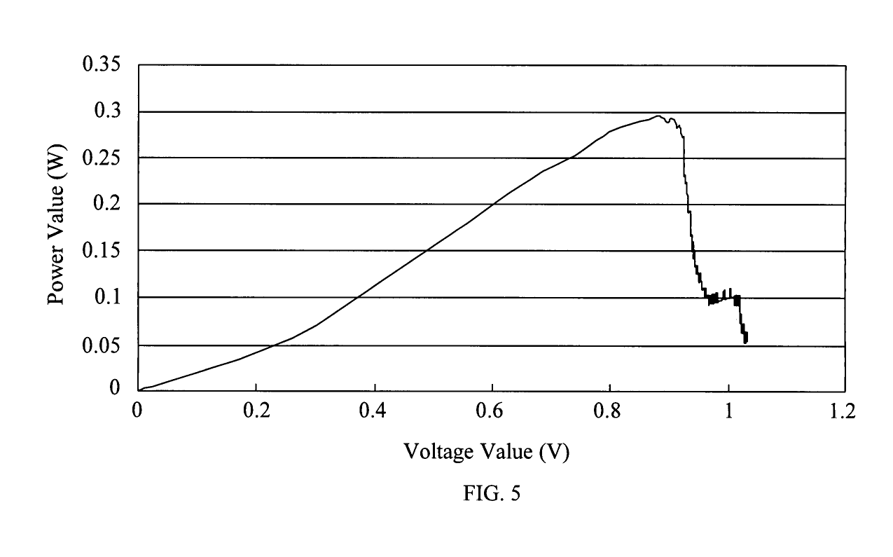

This embodiment is the same as Example 1, in which zinc is also selected as the first electrode, and copper is selected as the second electrode. Four copper electrodes (2.0 mm*60 mm) and four zinc electrodes (2.0 mm*60 mm) comprised in one set are inserted longitudinally on the pseudostem of the same one banana plant (about 6-8 months). There are three sets of electrodes as mentioned above which are respectively inserted on the pseudostems of three different banana plants with 50 mm of depth. The four copper electrodes and the four zinc electrodes in the same one banana plant are connected respectively in parallel, and are measured with voltage. The copper electrodes and zinc electrodes located in the different banana plant are connected in series, and are measured with voltage. These banana plants are further connected with a voltage and current recorder and a load, such as a rechargeable battery, nickel-hydrogen battery with 1.2 V and 1200 mA/H, via a conducting wire. The schematic architectural diagram of the banana plant cell for this embodiment and an equivalent circuit thereof are shown as FIGS. 2A and 2B. After turning on the recorder, and the voltage and current are continuously recorded for seven days, in which values of the voltage and current are measured and recorded every ten seconds. The average voltage curve, average voltage curve and average power curve obtained by means of monitoring continuously the banana plant cell for seven days are respectively shown as FIGS. 3, 4, and 5, wherein the voltage of the load before charging is 0.883 V. Therefore, according to the curves in FIGS. 3, 4, and 5, it is obviously known that the banana plant cell of the present invention can achieve the efficiency of long-lasting power supply.

One of the reasons that the banana plant cell in accordance with the present invention is that the banana plant comprises organic acids capable of using as the electrolyte. The organic acids in the banana plant comprise corosolic acid belonging to a triterpenoid, and can be used to develop the banana plant cell if operating in coordination with the zinc and copper electrodes. The cell reaction is supposed as follows:

The oxidation half-reaction of the zinc electrode: mZn+nR(H)ₒ→ZnₘRₙ+(n×o)H⁺+(n×o)e⁻

The reduction half-reaction of the copper electrode: 2H⁺+2e⁻→H_{2(g})

The overall cell reaction: mZn+nR(H)ₒ→ZnₘRₙ+½(n×o)H_{2(g)}

Wherein, R(H)ₒ denotes the organic acids (e.g. corosolic acid) within the banana plant, and o denotes the number of dissociable hydrogen ions of the organic acids.

Theoretically, the electric potential of the herbaceous plant cell varies with the different kinds of the organic acids. The right amount of water content and an appropriate electrolyte may provide maximum voltage and current performance. However, plants comprising the organic acids (e.g. corosolic acid) capable of using as the electrolyte do not mean that they can be effectively used as batteries for power supply. For example, according to the tests of several plants comprising relatively large amount of corosolic acid, such as a loquat tree, houseleek, aloe and cactus, or kumquat fruits on a kumquat tree, the inventor of the present invention found that a rotten phenomenon occurred in the plant issues of all these plants/fruits surrounding the electrodes, and even premature fruit drop occurred, thereby not able to supply electrical power continuously. Nevertheless, in accordance with the present invention, various electrodes are directly inserted on the pseudostems of the banana plants, and are performed with observation of electricity for more than two months. It is found that there is no the rotten problem occurred in the plant tissues, and the banana plant cell is able to supply electrical power continuously.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A banana plant cell, comprising:
at least one banana plant being a live plant, each the banana plant comprising at least one organic acid as an electrolyte;
at least one first electrode as an anode, inserted on the at least one banana plant; and
at least one second electrode as an cathode, inserted on the at least one banana plant, and electrically connected with the at least one first electrode.

2. The banana plant cell of claim 1, wherein the banana plant belongs to Musaceae.

3. The banana plant cell of claim 1, wherein a material of the first electrode comprises magnesium, zinc, or aluminum.

4. The banana plant cell of claim 1, wherein a material of the second electrode comprises graphite, copper, silver, platinum, or gold.

5. The banana plant cell of claim 1, further comprising a plurality of the first electrodes and a plurality of the second electrodes, wherein the plurality of first electrodes and the plurality of second electrodes are inserted on the same one banana plant in parallel.

6. The banana plant cell of claim 1, further comprising a plurality of the banana plants, a plurality of the first electrodes and a plurality of the second electrodes, wherein the plurality of first electrodes and the plurality of second electrodes are inserted on the different banana plants in series.

7. The banana plant cell of claim 1, wherein the first electrode and the second electrode are inserted on a pseudostem of the banana plant.

8. The banana plant cell of claim 1, wherein the first electrode is connected to the second electrode by a conducing wire.

9. The banana plant cell of claim 1, wherein the organic acid comprises corosolic acid.

10. The banana plant cell of claim 1, further comprising a recorder to record voltage and current.

11. The banana plant cell of claim 1, further comprising a load.

12. The banana plant cell of claim 11, wherein the load is an object to be supplied with electricity.

13. The banana plant cell of claim 12, wherein the load comprises an electric lamp, a light bulb, a rechargeable battery or a motor.
